(19) United States
(12) Patent Application Publication
(10) Pub. No.: US 2010/0302376 A1
(43) Pub. Date: Dec. 2, 2010

(54) SYSTEM AND METHOD FOR HIGH-QUALITY REAL-TIME FOREGROUND/BACKGROUND SEPARATION IN TELE-CONFERENCING USING SELF-REGISTERED COLOR/INFRARED INPUT IMAGES AND CLOSED-FORM NATURAL IMAGE MATTING TECHNIQUES

(76) Inventors: PIERRE BENOIT BOULANGER, Edmonton (CA); Yilei Zhang, Edmonton (CA)

Correspondence Address: ULMER & BERNE, LLP;ATTN: DIANE BELL, 600 VINE STREET, SUITE 2800, CINCINNATI, OH, 45202-2409, US

(21) Appl. No.: 12/727,654

(22) Filed: Mar. 19, 2010

Related U.S. Application Data
(60) Provisional application No. 61/181,495, filed on May 27, 2009.

(51) Int. Cl. H04N 5/33

(52) U.S. Cl. 348/164; 348/E05.09

(57) ABSTRACT

An apparatus and method is provided for near real-time, bi-layer segmentation of foreground and background portions of an image using the color and infrared images of the image. The method includes illuminating an object with infrared and visible light to produce infrared and color images of the object. An infrared mask is produced from the infrared image to predict the foreground and background portions of the image. A trimap is produced from the color image to define the color image into three distinct regions. A closed-form natural image matting algorithm is applied to the images to determine the foreground and background portions of the image.

### CROSS REFERENCE TO RELATED APPLICATIONS

This application claims priority of U.S. provisional patent application Ser. No. 61/181,495 filed May 27, 2009 and hereby incorporates the same provisional application by reference herein in its entirety.

### TECHNICAL FIELD

The present disclosure is related to the separation of foreground and background images using a fusion of self-registered color and infrared (“IR”) images, in particular, a sensor fusion system and method based on an implementation of a closed-form natural image matting algorithm tuned to achieve near real-time performance on current generation of the consumer level graphics hardware.

### BACKGROUND

Many tasks in computer vision involve bi-layer video segmentation. One important application is in teleconferencing, where there is a need to substitute the original background with a new one. A large number of papers have been published on bi-layer video segmentation. For example, background subtraction techniques try to solve this problem by using adaptive thresholding with a background model [1].

One of the most well known techniques is chroma keying which uses blue or green backgrounds to separate the foreground objects. Because of its low cost, it is heavily used in photography and cinema studios around the world. On the other hand, these techniques are difficult to implement in real office environment or outdoors as the segmentation results depend heavily on constant lighting and the access to a blue or green background. To remediate this problem, some techniques use learned backgrounds using frames where the foreground object is not present. Again, those techniques are plagued by ambient lighting fluctuations as well as by shadows. Other techniques perform segmentation based on stereo disparity map computed from two or more cameras [2, 3]. These methods have several limitations as they are not robust to illumination changes and scene features making dense stereo map difficult to get in most cases. They also have low computational efficiency and segmentation accuracy. Recently, several researchers have used active depth-cameras in combination with a regular camera to acquire depth data to assist in foreground segmentation [4, 5]. The way they combine the two cameras, however, involves scaling, re-sampling and dealing with synchronization problems. There are some special video cameras available today that produce both depth and red-green-blue (“RGB”) signals using time-of-flight, e.g. ZCam [6], but this is a very complex technology that requires the development of new miniaturized streak cameras which are hard to produce at low cost.

It is, therefore, desirable to provide a system and method for the bi-layer video segmentation of foreground and background images that overcomes the shortcomings in the prior art.

### SUMMARY

A new solution to the problem of bi-layer video segmentation is provided in terms of both hardware design and in the algorithmic solution. At the data acquisition stage, infrared video can be used, which is robust to illumination changes and provides an automatic initialization of a bitmap for foreground-background segmentation. A closed-form natural image matting algorithm tuned to achieve near real-time performance on currently available consumer-grade graphics hardware can then be used to separate foreground images from background images.

Broadly stated, a system is provided for the near real-time separation of foreground and background images of an object illuminated with visible light, comprising: an infrared (“IR”) light source configured to illuminate the object with IR light, the object located in a foreground portion of an image, the image further comprising a background portion; a color camera configured to produce a color video signal; an IR camera configured to produce an infrared video signal; a beam splitter operatively coupled to the color camera and to the IR camera whereby a first portion of light reflecting off of the object passes through the beam splitter to the color camera, and a second portion of light reflecting off of the object reflects off of the beam splitter to the IR camera; an interference filter operatively disposed between the beam splitter and the IR camera, the interference filter configured to allow IR light to pass through to the IR camera; and a video processor operatively coupled to the color camera and to the IR camera and configured to receive the color video signal and the IR video signal, the video processor further comprising video processing means for processing the color and IR video signals to separate the foreground portion of the image from the background portion of the image and to produce an output video signal that contains only the foreground portion of the image.

Broadly stated, a method is provided for the near real-time separation of foreground and background images of an object illuminated with visible light, the method comprising the steps of: illuminating the object with infrared (“IR”) light; producing a color video image of the object, the color video image further comprising a color foreground portion and a color background portion; producing an IR video image of the object, the IR video image further comprising an IR foreground portion and an IR background portion; producing a refined trimap from the color video image and the IR video image, the refined trimap defining a trimap image of the object further comprised of a foreground portion, a background portion and an unknown portion; producing an alpha matte from the color video image and the refined trimap; and separating the color foreground portion from the color background portion of the color video image by applying the alpha matte to the color video image.

Broadly stated, a system is provided for the near real-time separation of foreground and background images of an object illuminated with visible light, comprising: means for illuminating the object with infrared (“IR”) light; means for producing a color video image of the object, the color video image further comprising a color foreground portion and a color background portion; means for producing an IR video image of the object, the IR video image further comprising an IR foreground portion and an IR background portion; means for producing a refined trimap from the color video image and the IR video image, the refined trimap defining a trimap image of the object further comprised of a foreground portion, a background portion and an unknown portion; means for producing an alpha matte from the color video image and the refined trimap; and means for separating the color foreground portion from the color background portion of the color video image by applying the alpha matte to the color video image.

### BRIEF DESCRIPTION OF THE DRAWINGS

FIG. 1 is a block diagram depicting a system to acquire color and infrared input images for foreground/background separation.

FIG. 2 is a pair of images depicting synchronized and registered color and infrared images where the color image is shown in gray-scale.

FIG. 3 is a pair of images depicting the color image and its corresponding trimap where the images are shown in gray-scale.

FIG. 4 is a block diagram depicting a system for processing the foreground/background separation of an image pair.

FIG. 5 is a flowchart depicting a process for foreground/background separation of an image pair.

FIG. 6 is a flowchart depicting a process of creating and refining a trimap in the process of FIG. 5.

FIG. 7 is a flowchart depicting a process of applying a closed-form natural image matting algorithm on a color image and the refined trimap of FIG. 6.

### DETAILED DESCRIPTION OF EMBODIMENTS

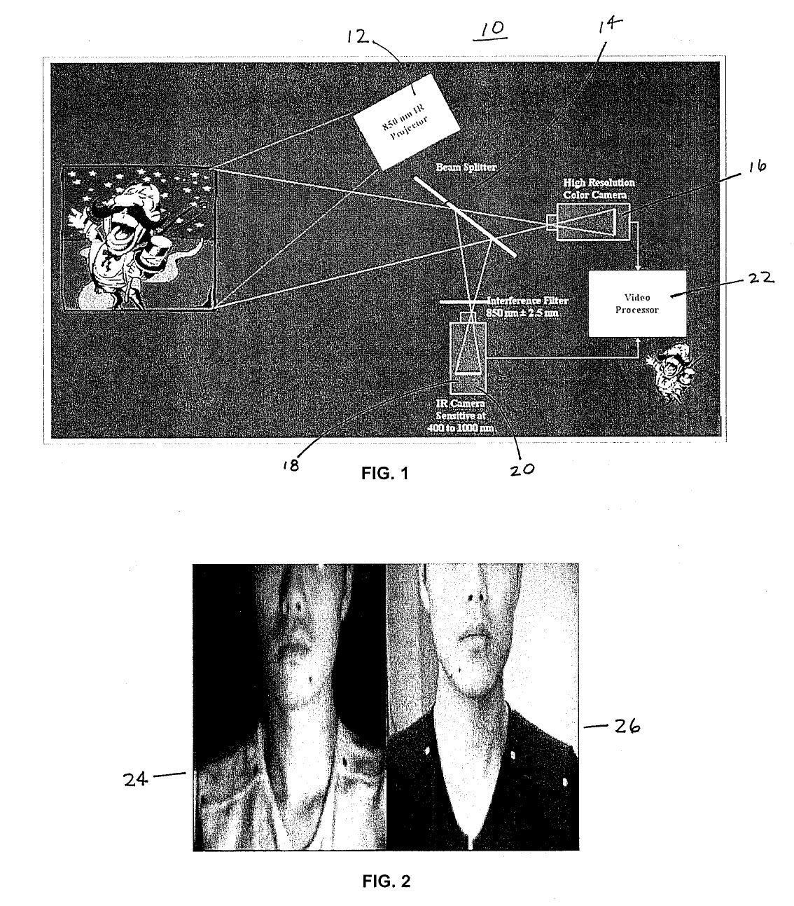

Referring to FIG. 1, a block diagram of an embodiment of data acquisition system 10 for the bi-layer video segmentation of foreground and background images is shown. In this embodiment, the foreground of a scene can be illuminated by invisible infrared (“IR”) light source 12 having a wavelength ranging between 850 nm to 1500 nm that can be captured by infrared camera 20 tuned to the wavelength selected, using narrow-band (±25 nm) optical filter 18 to reject all light except the one produced by IR light source 12. In a representative embodiment, an 850 nm IR light source can be used but other embodiments can use other IR wavelengths as well known to those skilled in the art, depending on the application requirements. IR camera 20 and color camera 16 can produce a mirrored video pair that is synchronized both in time and space with video processor 22, using a genlock mechanism for temporal synchronization and an optical beam splitter for spatial registration. With this system, there is no need to align the images using complex calibration algorithms since they are guaranteed to be coplanar and coaxial.

An example of a video frame captured by the apparatus of FIG. 1 is shown in FIG. 2. As one can see, IR image 24 captured using system 10 of FIG. 1 is a mirror version of color image 26 captured by system 10. This is due to the reflection imparted on IR image 24 by reflecting off of beam splitter 14. Mirrored IR image 24 can be easily corrected using image transposition as well known to those skilled in the art.

In one embodiment, system 10 can automatically produce synchronized IR and color video pairs, which can reduce or eliminate problems arising from synchronizing the IR and color images. In another embodiment, the IR information captured by system 10 can be independent of illumination changes; hence, a bitmap of the foreground/background can be made to produce an initial image. In a further embodiment, IR light source 12 can add flexibility to the foreground definition by moving IR light source 12 around to any object to be segmented from the rest of the image. In so doing, the foreground can be defined by the object within certain distance from IR source 12 rather than from the camera.

One aspect of IR image 24 is that it can be used to predict foreground and background areas in the image. IR image 24 is a gray scale image, in which brighter parts can indicate the foreground (as illuminated by IR source 12). Missing foreground parts must be within a certain distance from the illuminated parts.

To separate foreground object from background, a closed-form natural image matting technique [12] can be used. Formally, image-matting methods takes as input an image I, which is assumed to be a composite of a foreground image F and a background image B. The color of the i-th pixel can be assumed to be a linear combination of the corresponding foreground and background colors:

lᵢ=αᵢFᵢ+(1−αᵢ)Bᵢ (1)

where αᵢ is the pixel's foreground opacity. The collection of all αᵢ is denoted as an alpha matte of the original image I. With the generated alpha matte, one has the quantitative representation of how the foreground image and the background image are combined together, thus enabling the separation of the two.

In natural image matting, all quantities on the right-hand side of the compositing equation (1) are unknown, therefore, for a three-channel color image, at each pixel there are three equations and seven unknowns. This is a severely under-constrained problem, which requires some additional information in order to be solved—the trimap. A trimap, usually in the form of user scribbles, is a rough segmentation of the image into three regions:

i) foreground (αᵢ=1);

ii) background (αᵢ=0); and

iii) unknown.

The matting algorithm can then propagate the foreground/background constraints to the entire image by minimizing a quadratic cost function, deciding αᵢ for unknown pixels.

The fact that user inputs are necessary to sketch out the trimap hinders the possibility of matting in real-time. In one embodiment, however, IR image 24 in which the foreground object is illuminated by IR source 12 can be used as the starting point of a trimap and eliminates the need for user inputs. This can enable the matting algorithm to be performed in real-time. An estimate of the foreground area can be found by comparing IR image 24 against a predetermined threshold to produce a binary IRMask that can be defined as:

$${IRMask}_{i} = \{ \begin{matrix}1 , & if {IR}_{i} > T \\ 0 , & otherwise\end{matrix} \qquad ( 2 )$$

where T can be determined automatically using the Otsu algorithm [11].

Using the binary image, one can generate the estimated trimap by some more morphological operations [12] that can be defined as follows:

F={p|pεIRMask·erosion(s1)}

B={p|pε˜(IRMask·dilation(s2))}

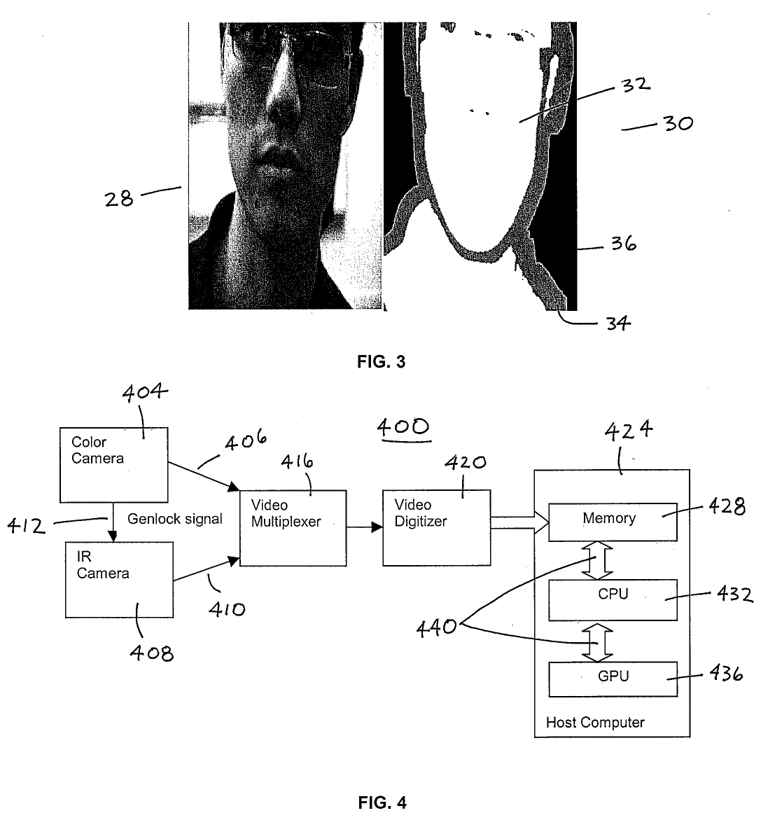

Unknown={p|pε˜(F+B)} (3)

where F stands for the foreground mask in the trimap, B stands for the background mask, and Unknown stands for the undecided pixels in the trimap. s1 and s2 are user-defined parameters to determine the width of the unknown region strip. Referring to FIG. 3, color image 28 (shown in gray-scale) and its trimap 30 is shown. Trimap 30 comprises of foreground region 32, background region 36 and unknown region 34. Trimap 30 can be an 8-bit grayscale image color-coded as defined below:

$${Trimap}_{i} = \{ \begin{matrix}0 if i ∈ B \\ 255 if i ∈ F \\ 128 if i ∈ Unknown\end{matrix} \qquad ( 4 )$$

In one embodiment, accumulated background can be introduced to further improve the quality of trimap 30. Without discreet user interaction, the fully automated IR driven trimap generation can be oblivious to fine details, for example, it can completely neglect a hole in the foreground objects whose radius is smaller than s2 due to the dilation process in equation (4). To counter this, a stable background assumption can be made, and a recursive background estimation method can be used [14] to maintain a single-frame accumulated background; then the current color image frame can be used to compare against the accumulated background and get a rough background mask; the holes in the foreground objects, therefore, can be detected in these rough background masks. The new background region in trimap 30 can then be a combination of two sources:

$$B = \{ p \vert \begin{matrix}p ∈ ∼ ( IRMask \cdot dilation ( s 2 ) ) \} \\ ⋃ \{ p \vert \vert {l}_{p} - {AccumBg}_{p} \vert < τ \vert\end{matrix} \} \qquad ( 5 )$$

This technique cannot deal with dynamic background, as the accumulated background would be faulty, hence, no useful background estimates can be extracted by a simple comparison between the wrongly accumulated background and the current color frame.

With the refined trimap and the color image, the closed-form natural image matting algorithm can be used to separate the foreground from background. In this embodiment of implementation, speed is a key concern as a real-time system is being targeted. Those skilled in the art know the high intensity of computation required by a natural image matting algorithm, thus some customizations can be made to achieve this. In one embodiment, all the steps mentioned below can be implemented on a graphics processing unit (“GPU”) to fully exploit the parallelism of the matting algorithm and to harness the parallel processing prowess of the new generation GPUs. This processing in whole can be performed at 20 HZ on a GTX 285 graphics card as manufactured by NVIDIA Corporation of Santa Clara, Calif., U.S.A., as an example.

Hardware Implementation

FIG. 4 illustrates one embodiment of a system (shown as system 400) that can carry out the above-mentioned algorithm. The two cameras (color camera 404 and IR camera 408) can be synchronized or “genlocked’ together using gunlock signal 412 of color camera 404 as the source of a master clock. One example of a suitable color camera is a model no. CN42H Micro Camera as manufactured by Elmo Company Ltd. of Cypress, Calif., U.S.A. A suitable example of an IR camera is a model no. XC-E150 B/W Analog Near Infrared camera as manufactured by Sony Corporation of Tokyo, Japan.

Color video signal 406 from color camera 404 and IR video signal 410 from IR camera 408 can then be combined together using side by side video multiplexer 416 to ensure perfect synchronization of the frames of the two video signals. An example of a suitable video multiplexer is a 496-2C/opt-S 2-channel S-video Multiplexer as manufactured by Colorado Video, Inc. of Boulder, Colo., U.S.A. High-speed video digitizer 420 can then convert the video signals from multiplexer 420 into digital form where each pixel of the multiplexed video signals can be converted into 24 bits integer corresponding to red, green or blue (“RGB”). An example of a suitable video digitizer is a VCE-Pro PCMCIA Cardbus Video Capture Card as manufactured by Imperx Incorporated of Boca Raton, Fla., U.S.A. In the case of the IR signal, the integer can be set to be R=G=B. Digitizer 420 can then directly transfer each digitized pixel into main memory 428 of host computer 424 using Direct Memory Access (DMA) transfer to obtain a frame transfer rate of at least 30 Hz. Host computer 424 can be a consumer-grade general-purpose desktop personal computer. The rest of the processing will be carried out with the joint effort of central processing unit (“CPU”) 432 and GPU 436, all interconnected by PCI-E bus 440.

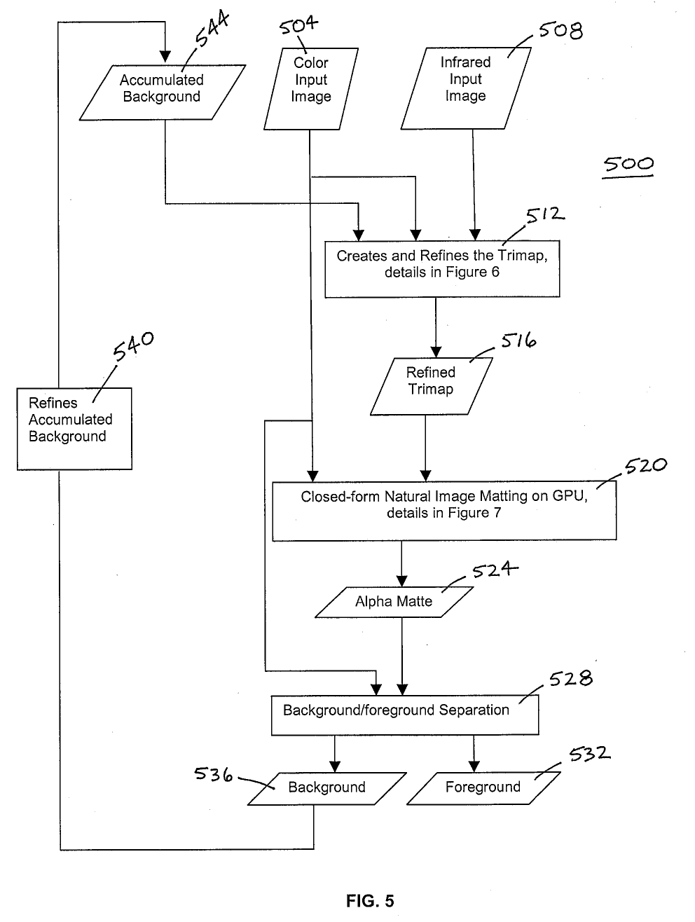

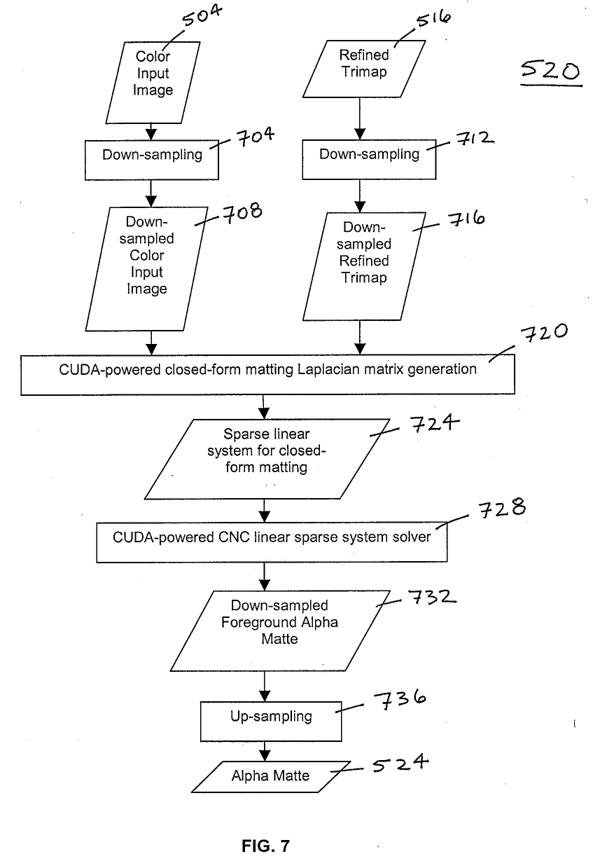

In one embodiment, the method described herein can be Microsoft® DirectX® compatible, which can make the image transfer and processing directly accessible to various programs as a virtual camera. The concept of virtual camera can be useful as any applications such as Skype®, H323 video conferencing system or simply video recording utilities can connect to the camera as if it was a standard webcam. In another embodiment, host computer 424 can comprise one or more software or program code segments stored in memory 428 that are configured to instruct one or both of CPU 432 and GPU 436 to carry out the methods described herein. In a representative embodiment, the software can be configured to instruct GPU 436 to carry out the math-intensive calculations required by the methods and algorithms described herein. As known to those skilled in the art, a general purpose personal computer with a CPU operating at 3 GHz can perform up to approximately 3 giga floating-point operations per second (“GFLOP”) whereas the NVIDIA GTX 285 graphics card, as described above, can perform up to approximately 1000 GFLOP. In this representative embodiment, host computer 424 can comprise the software that can control or instruct GPU 436 to carry out the closed-form natural image matting algorithm including, but not limited to, the steps for data preparation, down-sampling, image processing and up-sampling as noted in step 520 as shown in FIGS. 5 and 7, and as described in more detail below, whereas the steps concerning the receiving of the color and IR video signals from the color and IR cameras, and their integration with the DirectX® framework, can be carried out by CPU 432 on host computer 424.

Referring to FIGS. 5, 6 and 7, one embodiment of the method (shown as process 500 in FIG. 5) described herein can include the following steps.

1. Acquire color and infrared images at steps 504 and 508, respectively.

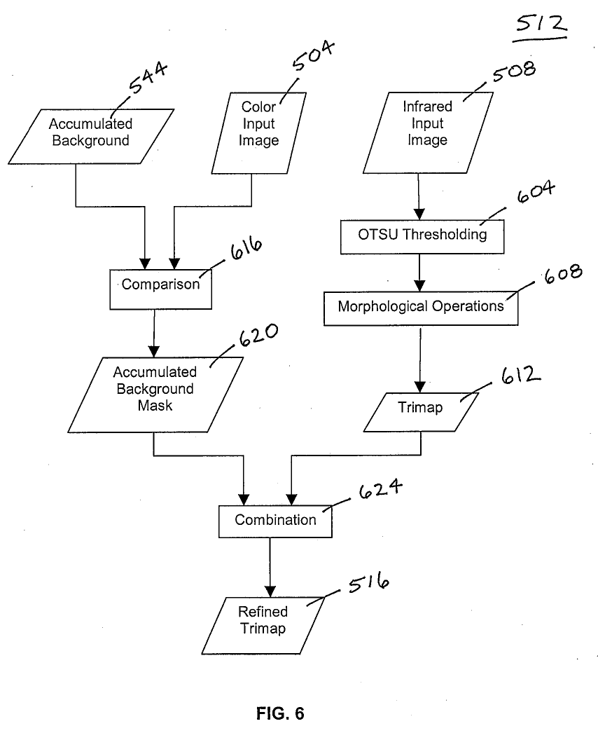

2. At step 512 (which is shown in more detail in FIG. 6), use Otsu thresholding to get the initial IRMask at step 604.

3. Use morphological operations on the IRMask at step 608 to get the initial trimap at step 612.

4. Compare the accumulated background from step 544 and the color image from step 504 at step 616 to create a accumulated background mask at step 620.

5. Combine the initial trimap from step 612 and the accumulated background mask from step 620 to obtain a refined trimap at step 516.

6. At step 520 (which is shown in more detail in FIG. 7), down-sample the color image from step 504 at steps 704 and 708, and down-sample the refined trimap from step 516 at steps 712 and 716.

7. Prepare the matting Laplacian matrix for the linear sparse system using the down-sampled color image and refined trimap from steps 708 and 716 at steps 720 and 724.

8. Solve the linear sparse system using CNC solver at step 728 to get the down-sampled foreground alpha matte at step 732.

9. Up-sample the foreground alpha matte at step 736 to get the final alpha matte at step 524.

10. Extract foreground and background from the color image at step 528 using the final alpha matte from step 524.

11. Use the extracted background at step 536 to refine the accumulated background at step 540 to produce the accumulated background at step 544.

12. The extracted foreground at step 532 can then be composited with a new background or simply sent over to the receiving end of the teleconferencing without any background image.

Referring the FIG. 7, the following discusses step 520, as shown in FIG. 5, in more detail.

Step 1: Down-Sampling of the Color Input Image and the Refined Trimap.

At steps 704 and 712, color image input 504 and refined trimap 516 can be down-sampled, respectively. The down-sampling rate should be carefully chosen as too large of a sampling rate would degrade the alpha matte result too much, while too small of a sampling rate would not improve the speed as much. In one embodiment, a down-sampling rate of 4 applied on a 640*480 standard resolution image (i.e., down-sampled to 160*120) can provide a good balance between performance and quality. It is obvious to those skilled in the art that a bi-linear interpolation, a nearest-neighbour interpolation or any other suitable sampling technique can be used to achieve this. In a representative embodiment, a bi-cubic interpolation can be applied.

For the trimap, it is important to notice that “0”, “128” and “255” are the only valid values. Thus, after the initial pass of the down-sampling process, a thresholding pass can be applied to set the new trimap values to the nearest acceptable values.

Step 2: Preparation of the Matting Laplacian.

At steps 720 and 724, a closed-form natural image matting matrix of the color input image can be created using a linear sparse system. For an input image size of w and h, let N=w*h where the Laplacian L can be a N*N matrix whose (i,j)th element can be defined as:

$${\sum }_{k \vert ( i , j ) ∈ {ω}_{k}} ( \begin{matrix}{δ}_{ij} - \frac{1}{\vert {ω}_{k} \vert} ( 1 + ( {I}_{i} - {μ}_{k} ) \\ {( {\sum }_{k} + \frac{ɛ}{\vert {ω}_{k} \vert} {I}_{3} )}^{- 1} ( {I}_{j} - {μ}_{k} ) )\end{matrix} ) \qquad ( 6 )$$

where:

k is the element whose 3×3 square neighbourhood window;

ωₖ should contain both i th and j th element, therefore, it is easy to see that i and j have to be close enough to have a valid set of k;

δᵢⱼ is the Kronecker delta where

$${δ}_{ij} = \{ \begin{matrix}1 if i = j \\ 0 otherwise ;\end{matrix}$$

|ωₖ| is the size of the neighbourhood window;

Iᵢ and Iⱼ are the i th and j th 3×1 RGB pixel vector from the color image;

μₖ is a 3×1 mean vector of the colors in the window ωₖ;

Σₖ is a 3×3 covariance matrix;

I₃ is the 3×3 identity matrix; and

ε is a user-defined regularizing term.

To actually extract the alpha matte matching the trimap, the following equation is to be solved:

α=αrgmin(α^{T}Lα+λ(α^{T}−bₛ^{T})Dₛ(α−bₛ)) (7)

where:
α is the alpha matte;
λ is some large number;
Dₛ is a N*N diagonal matrix whose diagonal elements are one for constrained pixels (foreground or background in the trimap) and zero for unknown pixels;
bₛ is the vector containing the specified alpha values for the constrained pixels and zero for all other pixels.

This amounts to solving the following sparse linear system:

(L+λDₛ)α=λbₛ (8)

Step 3: Solving the Linear Sparse System.

It is obvious to those skilled in the art that solving sparse linear systems is a well-studied problem, resulting in a lot of existing solutions. In a representative embodiment, a Concurrent Number Cruncher (“CNC”) sparse linear solver [13] can be used at step 728, which is written in Compute Unified Device Architecture computer language (“CUDA™”) and can run on GPUs in parallel, which can further ensure the solver to be one of the fastest available. The alpha matte can be obtained at step 732 after the solver converges.

Step 4: Up-Sampling to Recover the Alpha Matte of the Original Size.

At step 736, bi-cubic interpolation can be used in the up-sampling of the down-sampled foreground alpha matte.

Although a few embodiments have been shown and described, it will be appreciated by those skilled in the art that various changes and modifications might be made without departing from the scope of the invention. The terms and expressions used in the preceding specification have been used herein as terms of description and not of limitation, and there is no intention in the use of such terms and expressions of excluding equivalents of the features shown and described or portions thereof, it being recognized that the scope of the invention is defined and limited only by the claims that follow.

### REFERENCES

This application incorporates the following documents [1] to [14] by reference in their entirety.
[1] N. Friedman, S. Russell, “Image Segmentation in Video Sequences: a Probabilistic Approach”, Proc. 13^{th} Conf. on Uncertainty in Artificial Intelligence, August 1997, pp. 175-181.
[2] C. Eveland, K. Konolige, and R. C. Bolles, “Background modeling for segmentation of video-rate stereo sequences”, Proc. IEEE Computer Vision and Pattern Recognition (CVPR), Santa Barbara, Calif., USA, June 1998, pp. 266-271.
[3] V. Kolmogorov, A. Criminisi, A. Blake, G. Cross, and C. Rother, “Bi-layer Segmentation of Binocular video”, Proc. CVPR, San Diego, Calif., US, 2005, pp. 407-414.
[4] N. Santrac, G. Friedland, R. Rojas, “High resolution segmentation with a time-of-flight 3D-camera using the example of a lecture scene”, Fachbereich mathematik und informatik, September 2006.
[5] O. Wang, J. Finger, Q. Yang, J. Davis, and R. Yang, “Automatic Natural Video Matting with Depth”, Pacific Conference on Computer Graphics and Applications (Pacific Graphics), 2007.
[6] G. Iddan and G. Yahav, “3D Imaging in the studio (and elsewhere)”, Proc. SPIE, 2001, pp. 48-55.
[7] R. A. Hummel and S. W. Zucker, “On the Foundations of Relaxation Labeling Processes”, IEEE Trans. Pattern Analysis and Machines Intelligence, May 1983, pp. 267-287.
[8] M. W. Hansen and W. E. Higgins, “Relaxation Methods for Supervised Image Segmentation”, IEEE Trans. Pattern Analysis and Machine Intelligence, September 1997, pp. 949-962.
[9] Y. Boykov, and M.-P. Jolly, “Interactive graph cuts for optimal boundary and region segmentation of objects in N-D images”, Proc. IEEE Int. Conf. on computer vision, 2001, CD-ROM.
[10] http://en.wikipedia.org/wiki/Morphological_image_processing
[11] http://en.wikipedia.org/wiki/Otsu's_method
[12] Levin, D. Lischinski, and Y. Weiss. “A closed form solution to natural image matting”. In Proceedings of IEEE CVPR, 2006.
[13] L. Buatois, G. Caumon, and B. Levy. “Concurrent Number Cruncher: An Efficient Sparse Linear Solver on the GPU”. In Proceedings of High Performance Computation Conference (HPCC), 2007.
[14] S. C. S. Cheung, and C. Kamath. “Robust techniques for background subtraction in urban traffic video”. In Proceedings of Visual Communications and Image Processing, 2004.

We claim:

1. A system for the near real-time separation of foreground and background images of an object illuminated with visible light, comprising:
a) an infrared (“IR”) light source configured to illuminate the object with IR light, the object located in a foreground portion of an image, the image further comprising a background portion;
b) a color camera configured to produce a color video signal;
c) an IR camera configured to produce an infrared video signal;
d) a beam splitter operatively coupled to the color camera and to the IR camera whereby a first portion of light reflecting off of the object passes through the beam splitter to the color camera, and a second portion of light reflecting off of the object reflects off of the beam splitter to the IR camera;
e) an interference filter operatively disposed between the beam splitter and the IR camera, the interference filter configured to allow IR light to pass through to the IR camera; and
f) a video processor operatively coupled to the color camera and to the IR camera and configured to receive the color video signal and the IR video signal, the video processor further comprising video processing means for processing the color and IR video signals to separate the foreground portion of the image from the background portion of the image and to produce an output video signal that contains only the foreground portion of the image.

2. The system as set forth in claim 1, wherein the video processing means further comprises means for producing a trimap image of the object from the color video signal and the IR video signal.

3. The system as set forth in claim 2, wherein the video processing means further comprises means for producing an alpha matte from the color video signal and the trimap image.

4. The system as set forth in claim 3, wherein the video processing means further comprises means for applying the alpha matte to the color video signal to separate the foreground portion of the image from the background portion of the image.

5. The system as set forth in claim 3, wherein the means for producing the alpha matte further comprises means for carrying out an algorithm to produce the alpha matte.

6. The system as set forth in claim 5, wherein the algorithm comprises a closed-form natural image matting algorithm.

7. The system as set forth in claim 1, wherein the video processor comprises a video digitizer for digitizing the color and IR video signals, and a general purpose computer operatively connected to the video digitizer, the general purpose computer further comprising:
a) a central processing unit (“CPU”);
b) a graphics processing unit (“GPU”) operatively connected to the CPU; and
c) a memory operatively connected to the CPU and to the GPU, the memory comprising at least one program code segment comprising instructions for one or both of the CPU and the GPU to separate the foreground portion of the image from the background portion of the image and to produce an output video signal that contains only the foreground portion of the image.

8. The system as set forth in claim 7, wherein the at least program code segment comprises instructions for one or both of the CPU and the GPU to produce a trimap image of the object from the color video signal and the IR video signal using an Otsu thresholding technique.

9. The system as set forth in claim 7, wherein the at least program code segment comprises instructions for one or both of the CPU and the GPU to produce an alpha matte from the color video signal and the trimap image using a closed-form natural image matting algorithm.

10. The system as set forth in claim 2, wherein the video processing means further comprises means to produce and refine an accumulated background image of the background portion of the image.

11. The system as set forth in claim 10, wherein the means for producing the trimap image is operatively configured to produce the trimap image of the object from the color video signal, the IR video signal and the accumulated background image.

12. A method for the near real-time separation of foreground and background images of an object illuminated with visible light, the method comprising the steps of:
a) illuminating the object with infrared (“IR”) light;
b) producing a color video image of the object, the color video image further comprising a color foreground portion and a color background portion;
c) producing an IR video image of the object, the IR video image further comprising an IR foreground portion and an IR background portion;
d) producing a refined trimap from the color video image and the IR video image, the refined trimap defining a trimap image of the object further comprised of a foreground portion, a background portion and an unknown portion;
e) producing an alpha matte from the color video image and the refined trimap; and
f) separating the color foreground portion from the color background portion of the color video image by applying the alpha matte to the color video image.

13. The method as set forth in claim 12, wherein the step of producing the refined trimap further comprises the steps of:
a) applying an Otsu thresholding technique to the IR video signal to produce an initial IR mask;
b) performing morphological operations on the initial IR mask to produce an initial trimap image; and
c) combining the color video image with the initial trimap to produce the refined trimap.

14. The method as set forth in claim 12, wherein the step of producing the alpha matte further comprises the steps of:
a) down-sampling the color video image;
b) down-sampling the IR video image;
c) applying a closed-form natural image matting algorithm to the down-sampled color and IR video images to produce a Laplacian N×N matrix of the color video image;
d) converting the Laplacian N×N matrix to a sparse linear system;
e) solving the sparse linear system to produce a down-sampled foreground alpha matte; and
f) up-sampling the down-sampled foreground alpha matte to produce the alpha matte.

15. The method as set forth in claim 12, further comprising the step of refining the separated color background portion to produce an accumulated background image of the object.

16. The method as set forth in claim 15, wherein the refined trimap is produced from the color video image, the IR video image and the accumulated background image.

17. A system for the near real-time separation of foreground and background images of an object illuminated with visible light, comprising:
a) means for illuminating the object with infrared (“IR”) light;
b) means for producing a color video image of the object, the color video image further comprising a color foreground portion and a color background portion;
c) means for producing an IR video image of the object, the IR video image further comprising an IR foreground portion and an IR background portion;
d) means for producing a refined trimap from the color video image and the IR video image, the refined trimap defining a trimap image of the object further comprised of a foreground portion, a background portion and an unknown portion;
e) means for producing an alpha matte from the color video image and the refined trimap; and
f) means for separating the color foreground portion from the color background portion of the color video image by applying the alpha matte to the color video image.

18. The system as set forth in claim 17, further comprising:
a) means for down-sampling the color video image;
b) means for down-sampling the IR video image;
c) means for applying a closed-form natural image matting algorithm to the down-sampled color and IR video images to produce a Laplacian N×N matrix of the color video image;
d) means for converting the Laplacian N×N matrix to a sparse linear system;
e) means for solving the sparse linear system to produce a down-sampled foreground alpha matte; and
f) means for up-sampling the down-sampled foreground alpha matte to produce the alpha matte.

19. The system as set forth in claim 17, further comprising means for refining the separated color background portion to produce an accumulated background image of the object.

20. The system as set forth in claim 19, wherein the refined trimap is produced from the color video image, the IR video image and the accumulated background image.
